(19) United States
(12) Patent Application Publication
(10) Pub. No.: US 2009/0133250 A1
(43) Pub. Date: May 28, 2009

(54) Universal impact tool head and method for seating wires in a connector

(76) Inventor: Robert W. Sullivan, Simi Valley, CA (US)

Correspondence Address: GENE W. ARANT, P.O. BOX 269, LINCOLN CITY, OR, 97367-0269, US

(21) Appl. No.: 12/290,544

(22) Filed: Oct. 30, 2008

Related U.S. Application Data
(60) Provisional application No. 61/003,558, filed on Nov. 16, 2007.

(51) Int. Cl. H01R 43/00

(52) U.S. Cl. 29/749; 29/857

(57) ABSTRACT

A tool head assembly and method for ganged connection of insulated conductors to the IDC connectors of an IDC connector panel, in which the positions of wire insert blades inside the tool head are adjusted and then locked in place before forcing the tool head and connector panel together.

### PRIORITY CLAIM

This application claims priority of my U.S. Provisional Application Ser. No. 61/003,558 filed Nov. 16, 2007.

### BACKGROUND OF THE INVENTION

In telephone technology a wall jack is a female connector, and a standard male type of connector plugs into it. Thus for a home telephone the phone set has a cord with a male connector on its end which plugs into the wall—that is, into a female connector that was previously installed in the wall.

In communications technology because of the high digital data rates that the electrical circuits have to handle it is necessary for each minute part of the circuitry to be precisely correct, both mechanically and electrically. It is now commonplace to use eight-wire cables for the data circuits. A typical female connector that may be fastened into the wall of a building, into the housing of an electronic apparatus, or into a connector block of a telephone office mainframe, is called an “Ethernet” type CAT X connector block (where CAT X is any 8 wire connector IE: CAT 5, CAT 6, CAT 7 etc.) This is a sophisticated version of the old-style telephone wall jack. The CAT X has a set of eight different internal electrical conductors.

To mate with a female CAT X connector or other similar connector a male connector of the RJ45 type is used. The RJ45 connector receives as many as eight wires, often from an eight-wire cable. The RJ45 has a set of eight output terminals to which its incoming wires are internally and individually electrically connected. These output terminals of the RJ45 mate with the eight separate internal electrical conductors of a CAT X connector when the RJ45 is plugged into a CAT X.

My U.S. Pat. No. 6,017,237 issued Jan. 25, 2000 shows an improved type of RJ45 connector sold commercially as the EZRJ45 where the EZRJ45 is a registered trademark of SULLSTAR Technology. The method of loading that connector with appropriate checking of the color-coded connections of its incoming wires is described and claimed in my U.S. Pat. No. 5,996,224 issued Aug. 3, 1999. The contact elements of the male connector (RJ45) must be precisely positioned relative to their own housing.

The CAT X connector has a front or open female end where the male RJ45 is plugged in. This part of the CAT X must have a fixed geometrical configuration so that the output terminals of the RJ45 will correctly and precisely engage with corresponding electrical conductors in the CAT X. Thus when a loaded RJ45 is plugged into a CAT X, its output terminals will correctly engage and mate with corresponding internal electrical contacts of the CAT X connector. At its other or rearward end the CAT X has a circuit board or panel type of structure, to which the wires from another cable or other circuitry may be connected. The circuit board on the back end of the CAT X may be of the IDC or Insulation Displacement Connector type. It will typically contain rows and columns of the IDC connectors. Sometimes these connections are part of a Local Area Network, or LAN. The CAT X must be externally “loaded”; that is, its incoming circuits must be connected to appropriate contact members in the circuit board or panel at the rearward or back end of the CAT X.

In the present state of the industry the electrician or tradesman has a special tool to help him or her connect wires from a cable end or other circuitry into the correct places in the circuit board or panel of the CAT X. A wire end insert tool known in the trade as a “110 blade” for an “impact termination tool” may be used to insert and connect incoming wires into the IDC circuit board of a CAT X connector or other similar connector.

The 110 blade, which may be generally described as a wire end insertion tool, has a flat blade end that bears against a single insulated wire for forcing the wire between a pair of knife blades of an insulation displacement type connector (IDC) in a termination panel. The knife blades of the IDC will close on the insulated wire by cutting through the insulation material and then biting into the metal conductor to make a firm electrical contact. In addition to the flat blade end that bears against an insulated wire for forcing it between a pair of IDC knife blades the 110 blade flat end also has a U-shaped opening which partially encircles the knife blades while the conductor is being inserted. The wire end insertion tool may be of the “insert and no cut” type or the “insertion and cut” type. After a wire is inserted the termination tool may also be called on to cut the protruding end of the wire.

For cutting a protruding wire end a wire cutting blade is mounted on the wire insertion tool perpendicular to its flat end and extends somewhat beyond the flat end of the wire insertion blade. Tools of that type are shown, for example, in FIG. 8 of the Fallandy U.S. Pat. No. 5,832,603, and in FIGS. 4 and 5 of my U.S. Pat. No. 1,096,564. The tool shown in my U.S. Pat. No. 7,096,564, which is typical of prior tools of this kind, has both an “insert only” or “no cut” end 12, and an “insertion and cut end” 16 which is used when a wire is to be cut.

In some instances a particular wire is being terminated at a connector panel of which a particular IDC connector is a part. For such a connection the “insert and cut end” of the tool is used. In other instances after one connection is made the conductor will need to continue beyond the particular connector panel. For such a connection the “no cut” tool end of the 110 wire end insertion tool is used to simply push the conductor into the pair of knife blades. A contact is made but no wire is cut. Thus the IDC connector may represent the termination of one end of a conductor, or it may be simply one connection point along the way for a conductor whose two respective ends are connected and terminated elsewhere, whether for telephone or data circuitry.

The housing of a CAT X as made by the manufacturer has in its interior a set of eight metal plates or contact members. The manufacturer makes the housing (hard plastic) and the metal plates and installs those plates inside the housing in their proper geometrical relationships. Part of the desired geometrical shape of the housing is to ensure that later, when the male part of a connector (RJ45) is inserted, it will fit into the female opening in the CAT X housing, and the contact elements on the male connector will correctly engage with the female contact elements in the housing. The connector panel or male end of the CAT X connector also has incoming wires which must be connected to it, whether done as a factory operation or in the field. This job of externally “loading” the CAT X with wires from whatever cable is being connected to it may often be a challenging task for a tradesman or electrician.

Whether for field operations or for factory operations it is desirable to load a number of wire ends into a CAT X in a single operation. Special tool heads for that purpose have been shown in the Fallandy U.S. Pat. Nos. 5,758,403 and 5,832,603 and in the Karrasch U.S. Pat. No. 7,103,968.

Since the electrical and mechanical parts of the CAT X or similar connectors are very small, and the desired level of precision in their mechanical connections and their electrical operation is very high, a great deal of difficulty has been experienced in achieving accurate and reliable circuitry within reasonable limits of time and expense.

Recent deregulation of the industry has made it possible for different manufacturers to have slightly different mechanical specifications for the circuit board or male end of the CAT X connectors, even though an industry standard for the geometrical configuration of the female end of the connector is still being met. This makes the task of loading the connector panel with its incoming wires more difficult, whether done as a factory operation or in the field. Especially for work in the field, the task of the tradesman or electrician is much harder, because in externally loading the connector he or she may find that their special tool head for loading the CAT X connectors being used on a particular job do not fit, even though they did fit the CAT X connectors being loaded on a previous job.

### PRIOR ART

The Fallandy U.S. Pat. No. 5,758,403 issued Jun. 2, 1998 shows a wire insert tool which may be selectively rotated to operate in either a “no cut” mode or an “insert and cut” mode.

The Fallandy U.S. Pat. No. 5,832,603 issued Nov. 10, 1998 shows a tool head for multiple wire insert tools, which will seat and cut multiple wires in a “ganged” arrangement.

The Alexander and Fallandy U.S. Pat. No. 7,073,245 issued Jul. 11, 2006 shows a blade head or tool head 30 in which a plurality of wire insertion blades 60 are supported. Movement of tool head 30 towards an IDC connector panel causes the multiple wire insert blades 60 to insert corresponding insulated conductors into corresponding IDC connectors of a connector panel. The wire insert blades 62 have fixed positions relative to the blade head carrier 70.

The Karrasch U.S. Pat. No. 7,103,968 issued Sep. 12, 2006 shows a cable 6 comprised of a plurality of wires which are to be terminated into insulation displacement slots of contacts in connector 8 via cable manager 2. After insulation surrounding the cable has been stripped, slots 40, 42 in the cable manager 2 hold the individual wires of cable 6 in their separate preparatory positions, and color coding assists an operator in ensuring that the position of each wire is correct. Cable manager 2 (which may also be described as a tool head) also has multiple wire insert blades 44, 46 mounted in it in fixed geometric relation to it. The cable manager or tool head is pushed into engagement with connector 8 to terminate the wires into their correct IDC connectors of connector 8. As this occurs, each wire that is preliminarily held in slots 40, 42 of the tool head 2 is pushed into the appropriate slot (not individually numbered in the Karrasch patent) in one of the IDCs of connector 8.

According to both Alexander and Karrasch, a tool head engages a connector panel in fixed relative positions to each other.

### THE PROBLEM AT HAND

It is known in the prior art that the CAT X type of connector has a female end, which receives an RJ45 male connector, and also a connector panel end which is to be loaded with wires from a cable. The connector panel end of the CAT X has a base or housing of fixed physical configuration, which supports a plurality of individual IDC connectors in fixed geometric positions relative to it. Each of the individual IDC connectors will receive from the cable an individual insulated conductor or wire. Each insulated wire from the cable is to terminate in the associated individual IDC connector. This is done with the aid of a particular vehicle, namely, a wire insert blade, also known as a wire termination blade. A plurality of the wire termination blades are used only with the tool head during the termination procedure but neither they nor the tool head become part of the remaining assembly after the wire termination has been completed.

A tool head that will carry the wire insert blades also has a fixed mechanical or physical configuration. In the prior art it is known for the tool head and the connector panel end to each have a base or housing of fixed physical configuration such that the tool head may be forced into a mating engagement with the CAT X in a predetermined geometric relation to each other. As shown in the Fallandy U.S. Pat. Nos. 5,758,403 and 5,832,603 and in the Karrasch U.S. Pat. No. 7,103,968 it is known in the art to provide a tool head housing that mates with a CAT X housing in predetermined geometric relation.

In the prior art the wire insert blades have been mounted in the supporting tool head in fixed positions relative to it. Therefore, in the prior art when the tool head is forced into mating engagement with the connector panel end of the CAT X the wire insert blades are forced into that relationship in fixed geometric relation with the IDC connectors carried by the connector panel.

Whether for field operations or factory operations it is desirable to load a number of wire ends from a cable into a CAT X in a single operation. Industry standard for the geometrical configuration of the female end of the CAT X connector is still usually being met throughout the industry. The same is not true for the IDC connector panel end of the CAT X. Recent deregulation has allowed some manufacturers to now have different mechanical specifications for the circuit board end of the CAT X connectors. This makes the task of loading the connector panel with incoming wires more difficult. A tradesman or electrician working in the field in externally loading the connectors on a particular job may find that his or her tool head does not fit the CAT X connectors being used on that job. The tool head may have fit the CAT X connectors that were being loaded on a previous job, but they do not fit on this job.

The lack of precisely correct fit of the connectors will inevitably degrade the quality of the electrical connections being made. The reduced quality of the installation may show up right away in one or more ways, or it may show up only much later, when some kind of very inconvenient problem occurs.

The lack of optimum fit may result from one or more of three different factors. First, the length of the wire insert blades (i.e., the distance by which they protrude from the housing of the tool head) may be either too long or too short. This will be referred to as the Z direction. Secondly, the positions of the wire insert blades may be “off specification” in a direction that is perpendicular to the longitudinal axes of the insulated conductors. This is referred to as a discrepancy in the lateral or Y direction. Third, the blades may be “off specification” in a direction parallel to the longitudinal axes of the conductor wires. This will be referred to as a discrepancy in the X direction.

Experience with currently manufactured tool heads has shown little problem matching the length of the wire insert blades (in the Z direction) with the depth of the connector panel of the CAT X connector. Variations in the X and Y directions, however, are significant. The positions of wire insert blades inside the tool head housing may be off specification in either the X or the Y direction, or both. It is therefore the purpose of the present invention to provide a universal tool head whose wire insert blades may be adjusted in either the X direction, or the Y direction, or both, so as to optimally accommodate whatever CAT X connectors are being used in a particular installation.

### SUMMARY OF THE INVENTION

According to the present invention, before engagement of a tool head with a connector panel in fixed positions relative to each other to terminate cable wires in corresponding IDCs of the connector panel, wire insert blades carried by the tool head are adjusted as necessary relative to the tool head and locked in place so as to position the wire insert blades correctly relative to the IDCs of the connector into which the corresponding wires are then going to be terminated.

### PARTS LIST

Parts List:
connector 10 for a CAT X and cable 17
   female end 11
   individual IDC 12
   knives 13 of IDC 12
   IDC panel 14
RJ45 15
CAT X Cable 17
Insulated conductor 18
Tool Head Assembly 20
   box-like housing 22
   side walls 24
   end walls 26
   bottom wall 27
   elongated slots 28 in end walls
   openings 29 in side walls
wire insert tool or blades 30
   rearward end 32
   forward end 34
      flat end 36 for wire insertion
   threaded hole 37
   hole for rod insertion 38
   side edge 39 for frictional retention
rods 40
   set screw 41
   rod ends 42 (slide in slots 28 in end walls 26)
   threaded nuts for rod ends 44 (outside end walls)

### SECOND AND THIRD EMBODIMENT

pressure plate 50
   threaded openings 51
   threaded bolts 52
   fingered or notched pressure plate 53

### DRAWING SUMMARY

FIGS. 1A, 1B, and 1C are an artistic illustration of the novel method of the present invention as applied to termination of a single insulated conductor in an IDC connector;

FIG. 2 is a schematic drawing of a system of apparatus within which the novel method of the present invention may be employed;

FIG. 3 is a perspective and exploded view of a tool head assembly in accordance with a first embodiment of the invention;

FIG. 4 is a perspective view as assembled in accordance with a first embodiment of the invention;

FIG. 5 shows the top, bottom and side views of the assembled apparatus in accordance with a first embodiment of the invention;

FIG. 6 is a perspective and exploded view of the second and third embodiment of the invention;

FIG. 7 is a perspective view as assembled of the second embodiment of the invention;

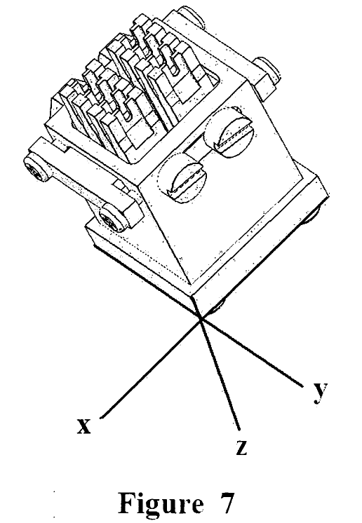

FIG. 8 shows the top, bottom and side views of the assembled apparatus of the second embodiment of the invention;

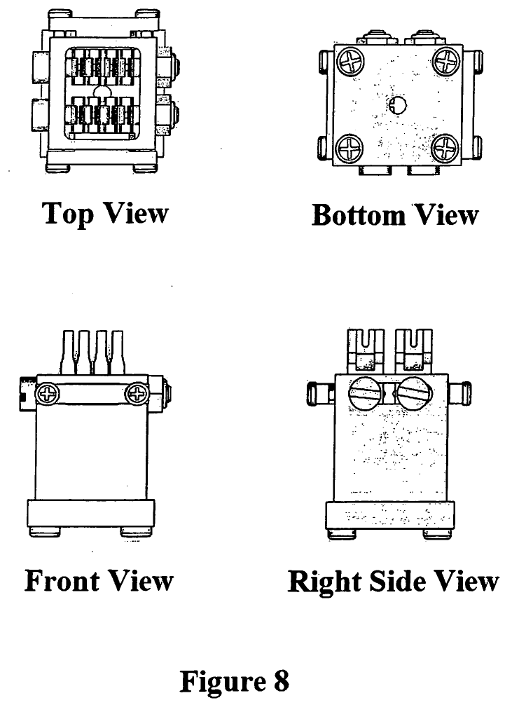

### DESCRIPTION OF THE METHOD

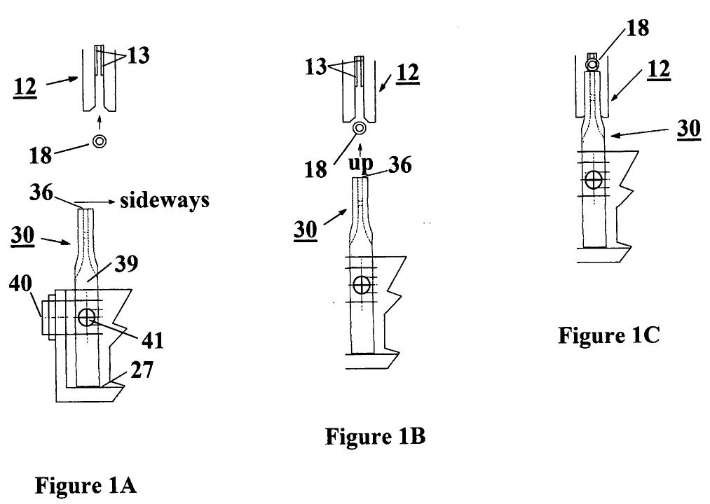

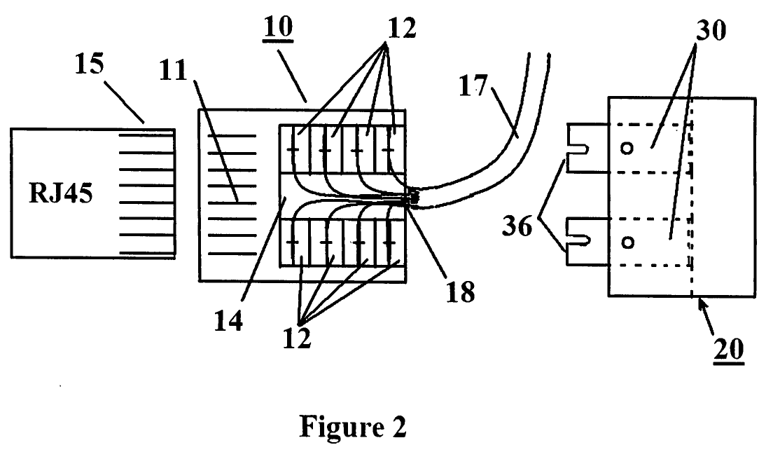

### FIGS. 1A, 1B, 1c and FIG. 2

In FIGS. 1A, 1B, and 1C the novel method of the invention is artistically illustrated as applied to installation of a single insulated conductor 18 in a connector 10 for a CAT X type cable. An individual IDC connector 12 is part of a connector panel 14, shown schematically in FIG. 2, for attachment to a cable 17 of a CAT X type of Ethernet cable. The individual IDC connector 12 has a conventional pair of knives 13. In some instances the conductor 18 will be both terminated and ended, with excess wire then being cut off from its end by use of a “cut blade”. In other instances the conductor will be installed or terminated at an intermediate point along its length, using a “no cut” blade. With a “no cut” installation, electrical current is then allowed to flow in either or both directions from the termination point.

FIG. 1A shows the IDC connector 12 above with its knives 13 pointing downward. Conductor 18 has been placed below the connector 12 in a properly centered position and is poised to be pushed upward into the connector, where the knives 13 will bite through the insulation in order to make a firm electrical contact. A wire insert tool or blade 30 with its longitudinal side edge 39 exposed to view is poised below the conductor 18 in order to push it upward and into engagement with the IDC connector. The blade ends 36 have a central notch, FIG. 2, which will straddle the knives 13. However, the wire insert tool as shown in FIG. 1A is positioned somewhat to the left of a correct position. In accordance with the novel method of the invention FIG. 1B shows the position of tool 30 having been adjusted somewhat to the right, where the flat wire insertion blade end 36 of tool 30 is then properly centered below both the wire 18 in the plane of the longitudinal axis of the wire and also below the IDC 12. This is a sideways adjustment in a lateral or Y direction, perpendicular to the longitudinal axes of the insulated conductors and also perpendicular to the plane of blade end 36. FIG. 1C shows the tool 30 having been forced upward, with its wire insertion blade end 36 having driven the wire 18 into proper termination in the knife blades 13 of IDC 12, all without any mechanical stress having been imposed in any inappropriate direction. Although not shown in FIG. 1, the positions of tools 30 may also be adjusted in the X direction.

### THE APPARATUS SYSTEM

### FIG. 2

FIG. 2 illustrates schematically the type of system within which the present invention is applied. A CAT X connector 10 for cable 17 has a female end portion 11, and also an IDC panel end 14 portion in which individual insulated conductors or wires 18 of cable 17 are to be terminated. Each conductor includes a wire covered by insulating material. A conventional male type RJ45 connector 15 will matingly engage the female end portion 11 of connector 10 in order to provide electrical continuity to the wires of cable 17. The RJ45 connector may optionally be my EZRJ45 patented type as referred to above. Individual conductors 18 will first be positioned for insertion into corresponding IDC connectors 12 of the IDC panel 14. A tool head assembly 20 supports a plurality of wire insert tools 30 which will be brought into engagement with the conductors 18, in order to force those conductors as a group into respectively corresponding IDC connectors 12 of panel 14. In accordance with the invention some or all of the wire insert tools 30 are adjustably disposed within the assembly 20 so that they may be precisely adjusted to mate with the corresponding connectors of panel 14. They may be adjusted in the Y direction in the manner illustrated by FIGS. 1A, 1B, and 1C, or in the X direction, or both, before the tool head assembly is forced into mating engagement with the connector panel 14.

### DESCRIPTION OF FIRST EMBODIMENT

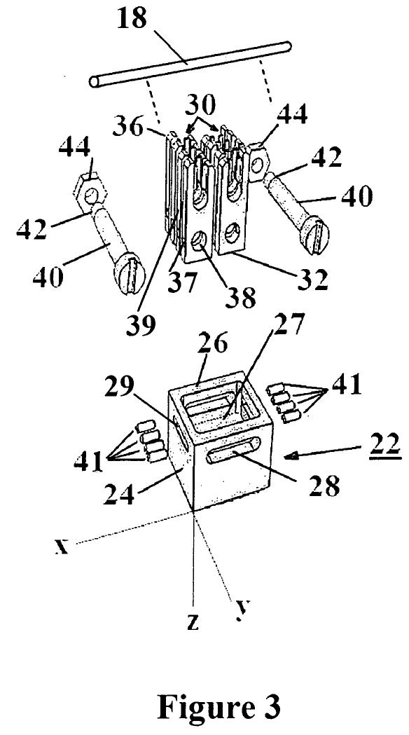

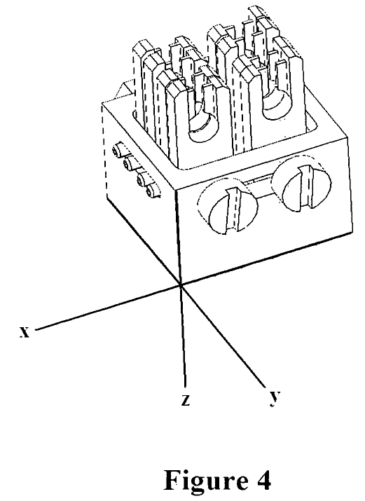

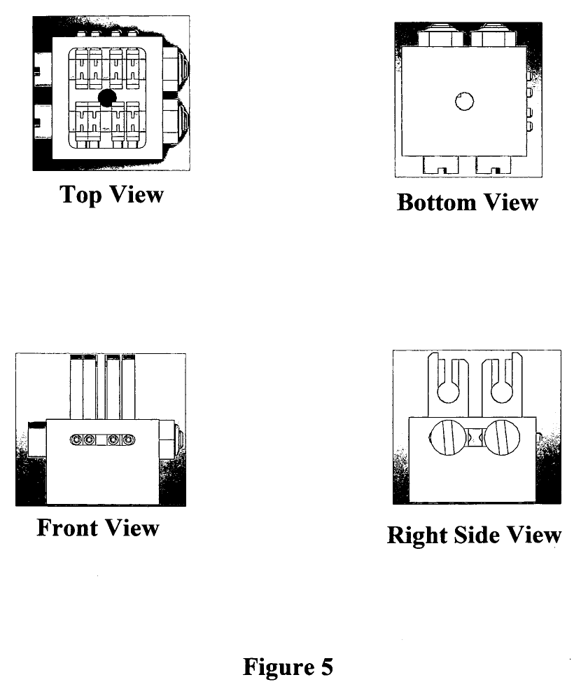

### FIGS. 3, 4, and 5

A First Embodiment of Tool Head Assembly 20 in Accordance with the invention includes a box-like housing 22, a pair of parallel side walls 24, a pair of parallel end walls 26, and a bottom wall 27. Elongated slots 28 are formed in end walls 26 extending parallel to each other and to the bottom wall 27. A pair of elongated rods 40 extend lengthwise inside the box 22, in substantially parallel relation to each other and to the plane of bottom wall 27. The ends 42 of rods 40 protrude through the slots 28 in the end walls 26, and are secured by respective threaded nuts 44 outside the end walls. Four wire insert tools or blades 30 are supported on each of the rods 40 in positions that are adjustable both laterally and longitudinally with respect to the box. Each tool 30 has a rearward end 32 and a forward wire insertion end 36.

Each wire insert tool 30 has a hole 38 which is nearer to its rearward end 32 than to the mid-point of its length, and through which the associated rod 40 passes in supporting relationship. The positions of the tools may be adjusted in the Y Direction, perpendicular to the longitudinal axes of the insulated conductors 18. To adjust the positions of the tools 30 in the Y direction perpendicular to the longitudinal axes of conductors 18 they may be made to slide along the supporting rod 40. Their positions may also be adjusted in the X direction, which is parallel to the longitudinal axes of the conductor wires. In the universal tool head assembly of the present invention the positions of the wire insert blades may be adjusted in either the X direction, or the Y direction, or both, so as to optimally accommodate whatever CAT X connectors are being used in a particular installation. To adjust the positions of the tools 30 in the X direction parallel to the longitudinal axes of conductors 18 the rods 40 may be made to slide sidewise in the elongated slots 28, and are then secured by nuts 44.

Thus, in general, the tool head assembly 20 for inserting a plurality of insulated conductors 18 into respective IDC connectors of connector panel 14 includes a box-like housing 22 having a base plate or bottom wall 27. Parallel end walls 26 extend upward perpendicularly from the base plate and are also perpendicular to parallel side walls 24. The end walls 26 of the box 22 have aligned openings or slots 28 which are elongated in a direction parallel to the base 27 for supporting the ends of the support rods 40. There is a separate support rod 40 for each row of tools 30. A pair of threaded nuts 44 placed outside the end walls 26 secure the ends of rods 40 in a position that may be adjusted laterally, in the Y direction. The four wire insert tools 30 in each row of tools are supported by a corresponding rod 40 which extends through their aligned holes or openings 38. Each wire insert tool 30 also has a rearward or bottom end 32 which rests upon the upper surface of bottom wall 27 in a slid able relationship therewith.

The position of tools 30 in the Y direction may be adjusted by sliding them lengthwise of the supporting rod 40. Set screws 41 passing inward through the elongated slots 29 in the side walls 24 are used to secure the individuals tools in position. Each set screw 41 engages a threaded opening in the side edge of the corresponding tool 30. Side edge 39 of tool 30 has a threaded opening 37 that will receive and be engaged by a set screw 41 which will also thus indirectly engage rod 40. Each set screw is tightened individually to secure the Y position of tool 30.

### SECOND EMBODIMENT

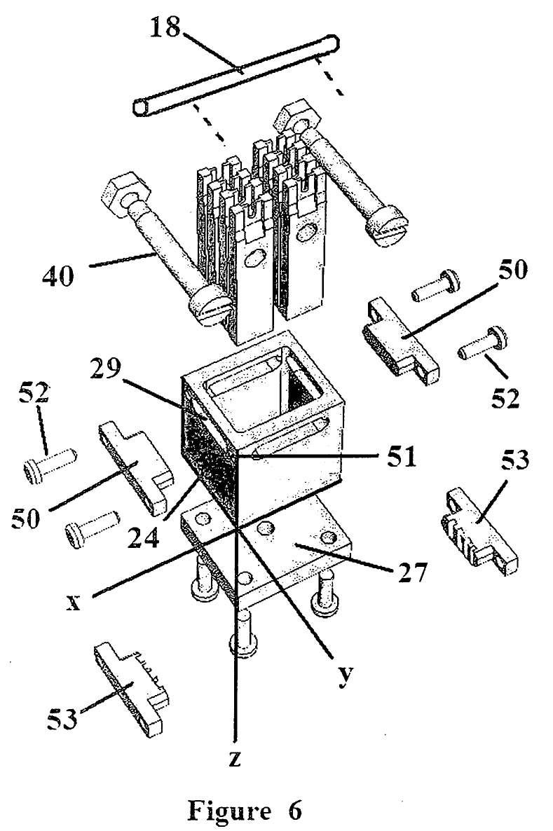

As shown in FIG. 6, the second embodiment of the invention differs in the mechanism for securing the tools 30 in their positions of longitudinal adjustment on the supporting rods 40. A pressure plate 50 projecting partially through elongated slot 29 of each of the side walls 24 geometrically captures and frictionally engages the side edges 39 of tools 30 to hold them in their adjusted positions. Each pressure plate 50 in turn is held in place by a pair of threaded bolts 52 which engage threaded openings 51 in the side wall 24 adjacent to the ends of slot 29. In the second embodiment the bottom wall 27 is also made as a separate plate, attachable to the side walls.

### THIRD EMBODIMENT

As a further and alternate embodiment a fingered pressure plate 53, also shown in FIG. 6, is made with fingers or notches in fixed locations to match the desired spacing of tools 30 for a particular brand or model of an IDC connector panel, so that field adjustment by a technician would not be required in order to precisely obtain the geometrically correct positions of the tools 30 with respect to rod 40.

### METHOD OF USE

The proper alignment of the tools 30 may be achieved by leaving all the adjustments mechanisms loose and mating the tool head assembly with a connector panel, but without any wires. Then the adjustment mechanisms are locked in place before using the tool head assembly to force a set of wires into the connector panel.

The scope of the invention is to be adjudged only in accordance with the appended claims.

What I claim is:

1. In a tool head assembly having multiple wire insertion blades which will need to engage corresponding connectors of an IDC connector panel when the tool head is mated with the connector panel in order to terminate insulated conductors in corresponding IDC connectors of the panel, the method of aligning the blades and terminating the conductors, comprising the steps of:
adjusting the three-dimensional positions of at least some of the blades with respect to the tool head;
locking the blades in their thus-adjusted positions relative to the tool head;
placing the tool head in mating engagement with the connector panel; and
then forcing the tool head and connector panel together so that each of the thus-adjusted blades terminates a corresponding insulated conductor in a corresponding individual IDC connector.

2. The method of claim 1 which includes applying force to some of the blades to move them in a direction perpendicular to their respective longitudinal axes before locking them in place.

3. A tool head assembly 20 for inserting a plurality of insulated conductors 18 into respective IDC connectors 12 of a connector panel 14, comprising:
a housing 22 having a base plate 27 with an inner surface, and parallel end walls 26 and side walls 24 which extend perpendicularly from the base plate 27 and also in perpendicularity to each other;
a plurality of wire insert tools 30 arranged in rows, each wire insert tool having a rearward end 32 that slidably engages the inner surface of the base plate 27;
the tools in each row of tools having aligned openings 38;
a separate support rod 40 for each row of tools which extends through the aligned openings of all of tools 30 in that row;
the housing end walls 26 having elongated aligned slots 28 through which the ends of each support rod 40 extends, the end wall slots being elongated in a direction parallel to the base of the housing so that the spacing of each row of tools from the housing side walls 24 may be adjusted by sliding the ends of rods 40; and
fastening means 44 external to the housing end walls 26 for securing the ends of each such support rod 40 in an adjusted position;
the rearward ends 32 of the wire insert tools 30 being laterally slidable upon the inner surface of the base plate 27 when such an adjustment is being made.

4. A tool head assembly as in claim 3 which further includes means for adjusting the position of each tool 30 in a longitudinal direction along the length of the associated support rod 40.

5. A tool head assembly as in claim 4 wherein the means for adjusting the longitudinal position of each tool 30 along the length of the associated support rod 40 includes a plurality of set screws 41, and elongated slots in the side walls 24 for receiving the set screws and permitting them to frictionally engage side edge 39 of the corresponding wire insert tools 30.

6. A tool head assembly usable after a plurality of insulated conductors have been preliminarily positioned, for engaging the conductors with respective IDC connectors of a connector panel and for then terminating the conductors into the respective IDC connectors of the connector panel, comprising:
a tool head housing having a base plate with a flat inner surface, and first and second pairs of parallel walls which extend perpendicularly from the base plate and also in perpendicularity to each other;
a plurality of wire insert tools having rearward ends and wire insert ends, the wire insert tools extending perpendicularly outward from the inner surface of the housing base plate with the rearward end of each insert blade engaging the inner surface of the base plate in laterally sliding relation with respect thereto;
the tools forming a row of tools having aligned openings;
a support rod which extends through the aligned openings of the row of tools; and
means for adjusting the position of each tool in a longitudinal direction along the length of the associated support rod.

7. A tool head assembly as in claim 6 wherein the means for adjusting the longitudinal position of each tool along the length of the associated support rod includes a plurality of set screws, and openings in the associated walls of the tool head housing for receiving the set screws and permitting them to frictionally support the corresponding wire insert tools in their adjusted positions.

8. A tool head assembly as in claim 6 wherein a pair of the housing walls have aligned openings through which the ends of the support rod extend, the wall openings being elongated in a direction parallel to the base of the housing so that the spacing of the row of tools from the associated pair of housing walls may be slidably adjusted; and fastening means external to the housing walls for securing the ends of the support rod in an adjusted position relative to the housing walls.

9. A tool head assembly for forcing a set of insulated conductors into electrical engagement with the respectively corresponding IDC connectors of a connector panel, comprising:
a box-like housing have parallel pairs of side and end walls and a bottom wall;
a rod extending between one pair of the walls with its ends supported thereby;
a group of elongated wire insert tools disposed within the housing and having aligned holes through which the rod extends, each tool having a rearward end slidably supported upon the inner surface of the bottom wall and having on its forward end a wire insert blade; and
adjustment means cooperating with the rod to allow the positions of the wire insert tools to be adjusted in a direction parallel to the bottom wall.

10. Apparatus as in claim 9 wherein the adjustment means includes elongated slots in the pair of walls that support the ends of the rod, the slots extending parallel to the bottom wall and the rod ends being slidable thereon so that the positions of the ends of the rod may be adjusted in a plane parallel to the bottom wall.

11. Apparatus as in claim 10 which further includes threaded nuts for securing the adjusted positions of the rod ends.

12. Apparatus as in claim 9 wherein the wire insert tools are slidably supported upon the rod that extends through their aligned holes, and which further includes;
longitudinally extending slots formed in the other pair of walls that extend parallel to the rod;
pressure fingers extending through the slots to engage the side edges of corresponding wire insert tools to secure their positions longitudinally of the rod; and
threaded means to secure the pressure fingers.

13. Apparatus as in claim 12 wherein the pressure fingers are provided by a pressure plate extending parallel to the rod and frictionally engaging the side edges of the wire insert tools to secure their longitudinal positions on the rod.

14. A tool head assembly as in claim 9 which further includes a pair of notched pressure plates protruding inward through openings in respective ones of the other pair of walls and engaging the insert tools to hold them in fixed locations longitudinally of the rod.

15. A tool head assembly for forcing a set of insulated conductors into electrical engagement with the respectively corresponding IDC connectors of a connector panel, comprising:
a box-like housing having parallel pairs of side and end walls and a bottom wall;
a pair of rods disposed parallel to the bottom wall and extending between the end walls;
elongated slots formed in the end walls and extending parallel to the bottom wall and slidingly supporting the respective ends of the rods so that the positions of the rods may be adjusted in a plane parallel to the bottom wall;
two groups of elongated wire insert tools disposed within the housing, having rearward ends slidingly supported upon the inner surface of the bottom wall and each having a wire insert blade on its forward end;
the wire insert tools also having aligned holes through which the corresponding rods extend in slidably supporting relationship therewith;
threaded nuts securing the adjusted positions of the rod ends;
elongated openings formed in the side walls of the housing; and
pressure means extending through the side walls openings and frictionally engaging the sides of the corresponding tools to secure the positions of side edges of corresponding wire insert tools longitudinally of the respective rods.

16. Apparatus as in claim 15 wherein the pressure means is a pair of pressure plates.

17. Apparatus used in claim 15 wherein the pressure means is a plurality of set screws, one for each insert tool.
